(19) United States
(12) Patent Application Publication
(10) Pub. No.: US 2002/0087864 A1
(43) Pub. Date: Jul. 4, 2002

(54) Method and arrangement for embedding a watermark in an information signal

(75) Inventors: Geert Florimond Gerard Depovere, Eindhoven (BE); Jaap Andre Haitsma, Eindhoven (NL); Antonius Adrianus Cornelis Maria Kalker, Eindhoven (NL)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/003,066

(22) Filed: Nov. 2, 2001

(30) Foreign Application Priority Data
Nov. 7, 2000 (EP) 00203893.3

(51) Int. Cl. H04L 9/00

(52) U.S. Cl. 713/176

(57) ABSTRACT

The invention relates to a method of embedding a watermark W in an information signal P, to a corresponding arrangement for embedding a watermark W in an information signal P, to an information signal P with an embedded watermark W and to a storage medium 50 having stored thereon an information signal P with an embedded watermark W. This method is carried out by determining local weight factors λ(P) for said watermark based on data of said information signal P, wherein said local weight factors λ(P) are determined such that the embedded watermark W is rendered substantially imperceptible when embedded in said information signal. The watermark W is locally weighted using said determined local weight factors λ(P). Then said locally weighted watermark is embedded in said information signal P. When determining said local weight factors λ(P) of said watermark W temporal data of said information signal are taken into account.

The invention relates to a method and arrangement for embedding a watermark in an information signal, an information signal with an embedded watermark, and a storage medium having stored thereon an information signal with an embedded watermark.

The ongoing digitalization of multimedia data has had a dual effect. While on the one hand it has enabled faster and more efficient storage, transfer and processing of signals, on the other hand duplication and manipulation of such signals has also become very easy and undetectable. Security concerns over copyright violation of multimedia data have also increased with the growth of computer networks like the Internet, which enable fast and error free movement of any unauthorized duplicate and possibly manipulated copy of multimedia information. Thus, there is a need to maintain some sort of copyright information in such open environment. These copyright information would need to be both easy to detect and yet hard to remove. The only solution appears to be to cement into the image, video or audio data a secondary signal that is not the perceptible and is bonded so well to the original data that it is inseparable and survives any kind of multimedia signal processing. Such secondary information is usually called a watermark.

Watermarking an image is essentially a process of altering the pixel values of an image in a manner that ensures that a viewer of the image does not notice any perceptual change between the original and the watermark image. Altering a large number of pixel values in an arbitrary manner will result in noticeable artifacts. Every pixel value of an image can be altered only to a certain limit without making perceptible differences to the image quality.

From WO 99/45705 a method for embedding auxiliary data in a signal is known. The data is encoded into the relative position or phase of one or more basic watermark pattern. To avoid that the watermark detection process needs to search the watermark over a large space, the watermark is generated by repeating smaller units called “tiles” over the extent of the image. Furthermore a local depth map or visibility mask λ(P) also referred to as local weight is computed. At each pixel position, λ(P) provides a measure for the visibility of additive noise.

In other words, λ(P) measures the local sensitivity of the image to degradation by additive noise, and is in practical situations determined by the magnitude of the response of a Langrangian high-pass filter L=[−1 −1 −1; −1 8 −1, −1 −1 1]. The value of the tiled watermark at each position is multiplied by the visibility value of λ(P) at that position. Accordingly, the equation for an information signal with an embedded watermark is as follows:

Q=P+λ(P)W (1)

where P is the information signal into which a watermark W is to be embedded resulting in an information signal Q with an embedded watermark W.

The next step would be to detect whether or not a particular watermark pattern W is included in the signal in question. The signal in question Q and the watermark pattern W are subject to correlation wherein the signal in question Q is possibly pre-filtered to increase the detection robustness. The watermark pattern W is detected to be present if a correlation value is larger than a given threshold.

In “Watermarking MPEG Video”, by Steven Weiss, Geoffrey Hoffman, in Computer Science 631: Multimedia Systems, Cornell University, Ithaca, N.Y., 1998 (also published on the webpage: http://hoffy.hoffyland.com/watermark/final.html) a method for watermarking MPEG video is suggested. A watermark is mainly applied to I-frames in a MPEG video sequence. To encode the frames a frame is first converted from RGB components to YUV components since only the Y (intensity) channel is watermarked, to make the watermark even more robust against any sort of color changes. To convert the frame into frequency coefficients a two dimensional DCT is performed on the entire frame to get an array of the same size containing all of the DCT coefficients. The watermark is added to the frame by scaling the value of the watermark by the value of the DCT coefficient. This way the low value coefficients are not destroyed while it is still possible to make an impact on larger value coefficients. To get the picture back again an Inverse Discrete Cosine Transformation I-DCT is performed on the data.

If enough information in the MPEG sequence stays constant or close to constant only encoding I-frames can give very good results, and will be quite fast as well. If more information is changing, it is better to encode the P frames as well. If speed is the highest priority while the signal still needs to be watermarked, then watermarking just the I-frames will give good results being only slightly slower.

In “Content Based Watermarking of Images”, Kankanhalli et al. 6th ACM International Multimedia Conference, 1998, Bristol, UK (also published on the webpage: http://info.acm.org/MM98/electronic_proceedings/kankanhalli/index.html) a new method of analyzing the noise sensitivity of every pixel based on the local region image content, such as texture, edge and luminance information is proposed. This results in a just noticeable distortion mask for the image to be watermarked. Then each bit of the watermark is spread spatially and shaped by a pseudo-noise sequence such that its amplitude is kept below the noise sensitivity of the pixel into which it is embedded.

Studies on the human perception of images have resulted in a so called Human Visual System (HVS). Details thereon are published in “Signal compression based on models of human perception”, by Johnston et al. in the Proceedings of the IEEE, 81 (10), page 1385 to 1422, October 1993.

According to the HVS the visibility of distortions in a region of the image depend on

Edge information of an image, which is a very important factor for the perception of an image. It has the least noise sensitivity and it is therefore essential to maintain edge integrity in order to preserve the image quality;

Smooth areas influence our perception together with the edge information;

In textures the distortion visibility is low, i.e. a strongly texture region has a very high noise-sensitivity level;

Brightness sensitivity: When the mean value of the square of the noise is the same as that of the background, the noise tends to be most visible against a mid-gray background, i.e. mid-gray regions are more sensitive to noise as compared to other regions.

The watermark is embedded into the image by scaling or weighting the watermark according to the noise sensitivity of the particular image region. This ensures that the watermark distorts the regions least that are sensitive to changes and exploits perceptional spatial redundancies in the areas of high detail and structure.

The watermark embedding methods known from the prior art have in common that they merely exploit spatial perceptional redundancies to incorporate watermark energy into the information signal.

It is an object of the invention to provide a method for embedding a watermark in an information signal, wherein said watermark is more robust as compared to known watermarks while the watermark detection is kept unchanged. Further a corresponding arrangement for embedding a watermark in an information signal, an information signal with an embedded watermark and a storage medium having stored thereon an information signal with an embedded watermark shall be provided.

This object is achieved according to the invention by a method as set forth in claim 1, by an arrangement as set forth in claim 8, by an information signal as set forth by claim 9 and by a storage medium as set forth in claim 10.

The invention is mainly based on the idea, that a watermark is embedded in an information signal by evaluating local scaling factors for the watermark using temporal data of said information signal. The local scaling factors are evaluated such that the embedded watermark is rendered substantially imperceptible when the watermark is embedded in said information signal based on the scaling factor. The watermark is locally scaled using the determined local scaling factors. Finally the locally scaled watermark is embedded in said information signal. Thus for the evaluation of the scaling factors temporal redundancies in the information signal can be exploited so that more watermark energy can be incorporated into the information signal without leading to a perceptible distortion.

According to a further aspect of the invention the local scaling factors for the watermark are evaluated using spatial and temporal data of said information signal. Thus for the evaluation of the scaling factors temporal and spatial redundancies in the information signal can be exploited so that more watermark energy can be incorporated into the information signal without leading to a perceptible distortion.

According to an aspect of the invention when evaluating the scaling factors the properties of the Human Visual System for still and/or moving images are taken into account.

In a further aspect of the invention the local scaling factors of the watermark are evaluated based on motion data of the information signal.

In still a further aspect of the invention scene changes in the information signal are detected and said local scaling factors are evaluated based on the detected scene changes. Accordingly, more watermark energy can be incorporated into specific regions of the information signal, increasing the total embedded watermark energy.

In still a further embodiment of the invention motion estimation is performed on said information signal and said local scaling factors are evaluated based on the motion estimation. The results of the motion estimation can therefore be used to incorporate more watermark energy more selectively into said information signal.

In a further aspect of the invention motion vectors, which have already been calculated for a video compression, are used to evaluate said local scaling factors.

In further embodiment of the invention an arrangement for embedding a watermark in an information signal is provided. Said arrangement comprises determining means for determining local scaling factors for said watermark based on temporal data of said information signal, wherein said local scaling factors of said watermark are determined such that the embedded watermark is rendered substantially not perceptible when embedded in said information signal. Said arrangement further comprises means for locally scaling said watermark using the determined local scaling factors and embedding means for embedding said locally scaled watermark in said information signal.

The invention is also embodied in an information signal with an embedded watermark as claimed in claim 9 and in a storage medium having stored thereon an information signal with an embedded watermark as claimed in claim 10. It shall be understood that the information signal and the storage medium can be further developed and that there are further embodiments thereof, which further developments and further embodiments are identical or similar to those described above with reference to the method of embedding a watermark in an information signal and are laid down in the subclaims of claim 1.

Other preferred embodiments of the invention are disclosed in the dependent claims.

The invention and preferred embodiments thereof are explained hereinafter in more detail with reference to the following drawings, in which

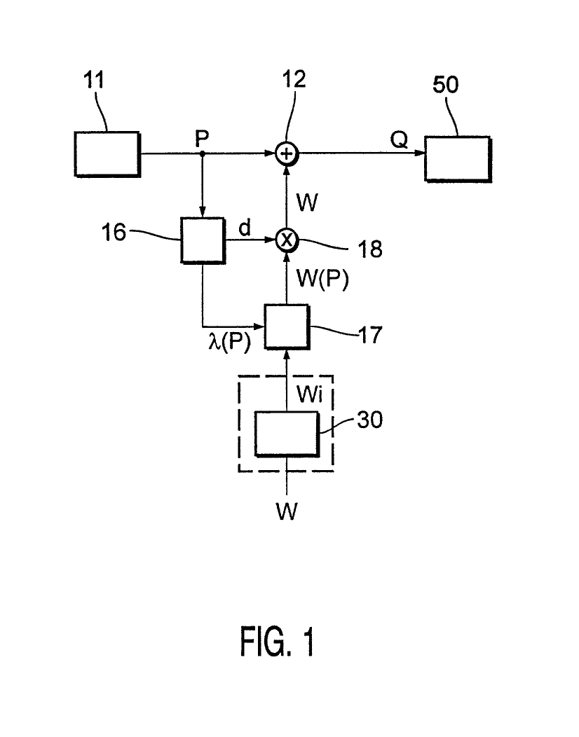

FIG. 1 shows a schematical block diagram of an arrangement for embedding a watermark in an information signal according to the invention, and

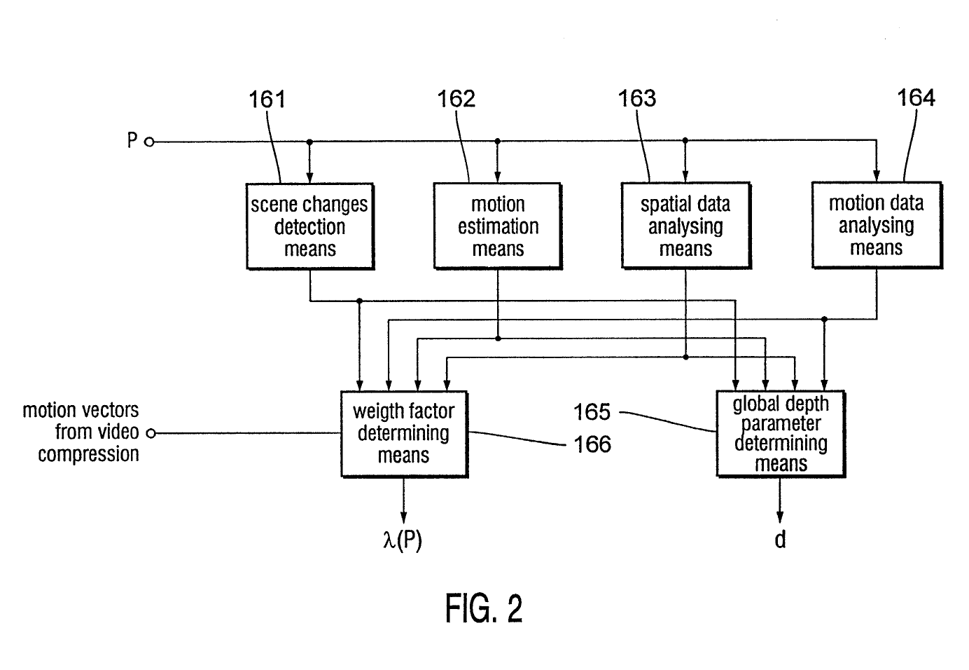

FIG. 2 shows a block diagram of a parameter determining means used in the arrangement for embedding a watermark in an information signal according to FIG. 1.

In FIG. 1 an embedder for embedding a watermark into an information signal is illustrated. The embedder includes an image source 11, which produces an information signal P, a parameter determining means 16 for determining weight factors λ(P) and a global depth parameter d, a modulator 17 for modulating the watermark W with the weight factors λ(P), a multiplier 18 for multiplying the modulated watermark W (P) with the global depth parameter d, and an adder 12 which adds a watermark W to the information signal P, resulting in a watermarked information signal Q. The resulting watermarked information signal Q can be stored on a storage medium 50.

In FIG. 2 the parameter determining means 16 is shown in more detail. The parameter determining means 16 includes a scene changes detection means 161, which has the information signal P as its input and is connected to a weight factor determining means 166 and a global depth parameter determining means 165 on its output side; a motion estimation means 162, which has the information signal P as its input and is connected to the weight factor determining means 166 and the global depth parameter determining means 165 on its output side; a spatial data analyzing means 163, which receives the information signal P as its input and is connected to the weight factor determining means 166 and the global depth parameter determining means 165 on its output side; and a motion data analyzing means 164 receiving the information signal P as its input and is connected to the weight factor determining means 166 and the global depth parameter determining means 165 on its output side. The weight factor determining means 166 also receives motion vector data from an external video compression (not shown) as input signal and generates weight factors λ(P) as its output signal. The global depth parameter determining means 165 generates the global depth parameter d as its output signal.

When determining the weight factors λ(P) with which each pixel in the information signal P is to be modulated i.e. multiplied, respectively, the spatial data of the information signal P is analyzed according to the properties of the Human Visual System HVS for still images by the spatial data analyzing means 163. This can for example be done by evaluating the well known JPEG quantization table. The analyzing results provide the information how much watermark energy can be embedded in a respective pixel of the information signal P without being percepted. According to the analyzing results a weight factor λ(P) for each pixel in the information signal P is determined, the watermark is weighted by multiplying the watermark pixels with the respective local weight factors, and is added to the respective pixels of the information signal by said adder 12. However, this is a purely spatial analysis of the information signal P.

According to the properties of the Human Visual System for moving images, the Human Visual System is insensitive to certain temporal changes in images. It is therefore possible to incorporate watermark energy into an information signal P with moving images. In the motion data analyzing means 164 several frames of the information signal P are analyzed in order to evaluate if any motion has taken place in said frames with respect to the temporal domain. Accordingly, additional watermark energy can be incorporated, according to the properties of the Human Visual System for moving images, into those regions of the image frame which are subject to temporal changes over several frames. Therefore, inter-frame movements are detected and are taken into account when determining the local weight factors λ(P).

The term motion data can be understood as data used to predict a frame B from a frame A. With a fixed geometric mechanism f( ), the frames A and B, and computed prediction data M, i.e. motion data, B will be approximately a function of A and M (f(a, M)). The local weight factor λ(P) will than be a function of the prediction data M, i.e. motion data. The motion data can be computed based on translation motion vectors, but also based on a rotation scheme, a shearing scheme or the like.

If scene changes are detected in the information signal P by the scene changes detection means 161 one measure to increase the watermark energy to be embedded in the information signal P is that the global depth parameter determining means 165 increases the global depth parameter d for some frames immediately after a scene changes. The particular method to detect scene changes is however not subject to the present invention but is well known in the prior art.

For image regions having a strongly directional preference, for example along edges, methods known in the prior art for adapting the watermark strength create artifacts in directions orthogonal to the dominant direction of the cover image. The reason for these artifacts is mainly the non-rectionality of both the watermark pattern W and the local weighting λ(P). As said local weighting λ(P) is directional insensitive, the watermark embedding method causes the introduction of watermark frequency components orthogonal in the case of dominant local directions.

Accordingly, in a further embodiment the watermark pattern W is split into several sub-patterns Wᵢ by the sub-pattern deriving means 30 as shown in FIG. 1, where each sub-pattern has a dominant orientation. For embedding the watermark the energy of the host signal, i.e. the information signal, is determined in each of the dominant directions in the spatial data analyzing means 163. This information is forwarded to the weight factor determining means 166, where the weight factors for the respective sub-patterns are determined accordingly. Each sub-pattern W₁ is weighted according to the determined weight factors by the multiplier 17 and is added to the information signal by the adder 12. By this splitting of the watermark pattern W into several sub-patterns Wᵢ the watermark pattern is made directional sensitive. By ensuring that the sum of the patterns Wᵢ is equal to the original pattern W, the watermark detection is still achieved by correlating the signal in question with the original mother pattern W.

Each of the sub-patterns Wᵢ derived from the single watermark pattern W has a power spectral density with most of its energy concentrated in a direction i (i=horizontal, vertical or diagonal).

The above is best explained by giving an example. Consider the original Laplacian sensitivity measure to be L=[−1 −1 −1; −1 8 −1; −1 −1 −1]. This sensitivity measure is, as already mentioned above, insensitive to orientation, but it can easily be split into four orientation sensitive measures as follows:

Lᵥ=[−1 −1 −1; 2 2 2; −1 −1 −1]

Lₙ=[−1 2 −1; −1 2 −1; −1 2 −1]

Lᵤ=[2 −1 −1, −1 2 −1; −1 −1 2]

L_{d}=[−1 −1 2; −1 2 −1; 2 −1 −1] (2)

The four directional filters {L₁} have the property that their total sum is equal to the original sensitivity filter L. The directional watermark patterns Wᵢ are now constructed as

Wᵢ=L₁ [symbol] (L+e)⁻¹ [symbol] W, (3)

where e is a small positive constant that prevents singularities at zeros of L. With this definition (i) the pattern Wᵢ has a dominant direction corresponding to the filter Lᵢ, and the sum of the four patterns is approximately equal to the original (“mother”) pattern W.

W=Wv+Wh+Wu+Wd (4)

The local weight factor λ(P) can be changed accordingly into four local weight factor matrixes or four local depth matrixes Λ=Λₕ+ΛᵥΛ_{d}+Λ_{d}.

The watermark embedding formula now becomes

W=P+dΣ|Lᵢ|Wᵢ, (5)

where d represents the global watermark strength. It is to be noted that in textured areas, with no preferential direction, this embedding formula is effectively equivalent to the original non-directional embedding method

Q=P+d |L|W. (6)

As each of the four patterns still has a strong correlation with the mother pattern W (approximately ¼ of the self-correlation of W), watermark detection is still possible by using correlation with the single pattern W.

In an embodiment of the present invention the use of motion estimation for watermarking an information signal is considered. When an image contains a block with large vertical frequencies (e.g. horizontal line patterns) λ(P) will be large in vertical directions, so that most watermark energy with relatively large vertical frequencies W, would be added. For a still image this is not visible, however for a video sequence with a strong horizontal motion component, this would not be the case anymore so that artifacts might appear. This fact can be understood from the properties of the Human Visual System (HVS) for moving images, since the HVS is more sensitive to orthogonal noise than to parallel noise.

If the motion vector in each pixel is denoted as a matrix M, it can be decomposed in the horizontal and vertical direction, resulting in M=Mₕ+Mᵥ as well as in the diagonal directions M=M_{d}+Mᵤ. The calculation of the motion vectors is well known from the prior art, for example from MPEG2 compression, and it is therefore not subject of the present invention. Sometimes it is useful to subdivide the video frame into blocks, for which the motion vectors are then calculated. The block size can be equal to the tiles mentioned above with reference to WO 99/45705, but also bigger blocks (ultimately the whole frame) or smaller blocks (ultimately one pixel) are possible. Accordingly, the embedding function can be changed to:

Q=P+dΣ[Λ₁Wᵢ(α+M₁)/(1+βMᵢ)]. (7)

where α>1 and β>1 are fixed constant values. In case of large motion in the i-direction (Mᵢ>>1) it is found that the watermark energy is reduced by a factor 1/β and in case of small motions in the i-direction (Mᵢ<<1) it is found that the watermark energy is amplified by a factor α.

The watermark detection can be achieved as described in WO 99/45705. Accordingly, known watermark detection methods can be applied.

1. Method of embedding a watermark (W) in an information signal (P) comprising the steps of:
determining local weight factors (λ(P)) for said watermark (W) based on data of said information signal (P), wherein said local weight factors (λ(P)) are determined such that the embedded watermark is rendered substantially imperceptible, when embedded in said information signal (P),
locally weighting said watermark (W) based on said determined local weight factors (λ(P)), and
embedding said locally weighted watermark in said information signal (P),
characterized by determining said local weight factors (λ(P)) of said watermark (W) based on temporal data of said information signal (P).

2. Method according to claim 1, characterized by determining local weight factors (λ(P)) for said watermark (W) based on spatial data of said information signal (P).

3. Method according to claim 1, characterized in that properties of the Human Visual System applied to still and/or moving images are taken into account when determining said local weight factors (λ(P)).

4. Method according to claim 1, characterized in that said local weight factors (λ(P)) of said watermark (W) are determined based on motion data of said information signal (P).

5. Method according to claim 1, characterized by detecting scene-changes in the information signal (P), and determining said local weight factors (λ(P)) based on the detected scene changes.

6. Method according to any one of claim 1, characterized by performing motion estimation on said information signal (P), and determining said local weight factors (α(P)) based on the motion estimation.

7. Method according to claim 6, characterized in that motion vectors already calculated by an external video compression process are used instead of performing the motion estimation again.

8. An arrangement for embedding a watermark (W) in an information signal (P) comprising:
determining means (16) for determining local weight factors (λ(P)) for said watermark (W) based on data of said information signal (P), wherein said local weight factors (λ(P)) of said watermark (W) are determined such that the embedded watermark is rendered substantially imperceptible when embedded in said information signal (P),
weighting means (17) for locally weighting said watermark (W) based on the determined local weight factors (λ(P)), and
embedding means (12) for embedding said locally weighted watermark (W) in said information signal (P),
characterized in that said determining means (16) for determining said local weight factors (λ(P)) for said watermark (W) are provided for determining said local weight factors (λ(P)) based on temporal data of said information signal (P).

9. An information signal (P) with an embedded watermark (W), wherein said watermark (W) is embedded in said information signal (P),
wherein local weight factors (λ(P)) for said watermark (W) are determined based on data of said information signal (P), said local weight factors (λ(P)) being determined such that the embedded watermark is rendered substantially imperceptible when embedded in said information signal (P),
wherein said watermark (W) is locally weighted based on said determined local weight factors (λ(P)), and
wherein said locally weighted watermark (W) is embedded in said information signal (P),
characterized in that said local weight factors (λ(P)) of said watermark (W) are determined based on temporal data of said information signal (P).

10. A storage medium (50) having stored thereon an information signal (P) with an embedded watermark (W), wherein said watermark (W) is embedded in said information signal (P),
wherein local weight factors (λ(P)) for said watermark (W) are determined based on data of said information signal (P), said local weight factors (λ(P)) being determined such that the embedded watermark is rendered substantially imperceptible when embedded in said information signal (P),
wherein said watermark (W) is locally weighted based on said determined local weight factors (λ(P)), and
wherein said locally weighted watermark (W) is embedded in said information signal (P),
characterized in that said local weight factors (λ(P)) of said watermark (W) are determined based on temporal data of said information signal (P).
